(19) United States
(12) Patent Application Publication
(10) Pub. No.: US 2016/0063505 A1
(43) Pub. Date: Mar. 3, 2016

(54) NATURAL LANGUAGE PROCESSING (NLP) OF FOLLOW UP TO A SCHEDULED EVENT IN A CUSTOMER RELATIONSHIP MANAGEMENT (CRM) SYSTEM

(71) Applicant: SugarCRM Inc., Cupertino, CA (US)

(72) Inventor: Bruce Bradley, Scotts Valley, CA (US)

(21) Appl. No.: 14/469,407

(22) Filed: Aug. 26, 2014

(51) Int. Cl. G06Q 30/00; G06F 17/28; G06Q 10/10

(52) U.S. Cl. CPC G06Q 30/01; G06Q 10/1095; G06F 17/28

(57) ABSTRACT

The present invention provides for natural language processing (NLP) follow up to a meeting in a calendaring and scheduling (C&S) component of a customer relationship management (CRM) system. A method for NLP follow up to a meeting in a C&S component of a CRM system includes scheduling a meeting from an end user in a C&S component of a CRM system. The method also includes loading a document of the end user such as an e-mail message or speech recognized text, and extracting a context for the document. The method yet further includes matching the context to the scheduled meeting and performing NLP on at least a portion of the document to produce data pertaining to at least one CRM object in the CRM system associated with the scheduled meeting. Finally, the method includes updating the CRM object with the produced data.

### BACKGROUND OF THE INVENTION

1. Field of the Invention

The present invention relates to CRM event processing and more particularly to meeting follow up in a CRM application.

2. Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

Elemental to any CRM system is a calendaring and scheduling (C&S) component in which meetings and tasks can be scheduled, oftentimes in association with a particular date and time. Unlike a basic C&S system, however, in a CRM system the C&S component integrates other CRM objects including particular business opportunities, particular contacts, and particular end users of the CRM system. As such, scheduling a meeting in the C&S component of a CRM system often requires the specification not only of a date and time for the meeting, but also a particular business opportunity, a particular individual associated with the particular business opportunity, and a particular end user of the CRM system.

The integration of C&S into CRM is not without its burden. Specifically, whereas in a traditional bare C&S application, the purpose of the scheduling of a meeting is merely to remind the end user of the necessity to attend the meeting and perhaps to provide some sort of electronic record of the occurrence of the meeting. Hence, the C&S application is but an organizational tool. However, when combined with CRM, a responsibility exists for the end user to modify CRM data in accordance with the goings on at the meeting. This sort of activity is known as “follow up”. Traditionally, follow up for a meeting requires the end user to return to a stationary position from where the end user can access the CRM system and update CRM objects pertaining to the business opportunity associated with the meeting.

The passage of time between the meeting and the act of following up, though, can result in the end user neglecting to record important changes to the relevant objects of the CRM system, or to neglect in engaging the follow up process in its entirety.

Consequently, the important advantage of the integration between CRM and C&S will have been lost.

### BRIEF SUMMARY OF THE INVENTION

Embodiments of the present invention address deficiencies of the art in respect to the integration of CRM and C&S and provide a novel and non-obvious method, system and computer program product for NLP follow up to a meeting in a C&S component of a CRM system. In an embodiment of the invention, a method for NLP follow up to a meeting in a C&S component of a CRM system is provided. The method includes scheduling a meeting from an end user in a C&S component of a CRM system. The method also includes loading a document of the end user such as an e-mail message or speech recognized text, and extracting a context for the document. The method yet further includes matching the context to the scheduled meeting and performing NLP on at least a portion of the document to produce data pertaining to at least one CRM object in the CRM system associated with the scheduled meeting. Finally, the method includes updating the CRM object with the produced data.

In one aspect of the embodiment, the method additionally includes determining that a threshold period of time has elapsed since a scheduled time for the meeting and prompting the end user to produce the document if the end user had not yet updated at least one CRM object in the CRM system associated with the scheduled meeting. In this regard, the end user can be prompted by way of a text message or by way of an e-mail message. In the latter circumstance, optionally, the end user is prompted by way of a voice prompt in automated telephone call and the document is produced by speech recognizing a voice message of the end recorded over the automated telephone call.

In another embodiment of the invention, a CRM system is configured for NLP follow up to a meeting. The system includes a host computing system that includes at least one computer with memory and at least one processor and a CRM application with a C&S component executing in the memory therein. Finally, the system includes an NLP processing module coupled to the CRM application and the C&S component. The module includes program code configured upon execution in the memory of the host computing system to schedule a meeting from an end user in the C&S component, to load a document of the end user and to extract a context for the document, to match the context to the scheduled meeting and performing NLP on at least a portion of the document to produce data pertaining to at least one CRM object in the CRM system associated with the scheduled meeting, and to update the CRM object with the produced data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for NLP follow up to a meeting in a C&S component of a CRM system;

FIG. 2 is a schematic illustration of a CRM data processing system configured for NLP follow up to a meeting; and,

FIG. 3 is a flow chart illustrating a process for NLP follow up to a meeting in a C&S component of a CRM system.

### DETAILED DESCRIPTION OF THE INVENTION

Embodiments of the invention provide for NLP follow up to a meeting in a C&S component of a CRM system. In accordance with an embodiment of the invention, a meeting can be scheduled in a C&S component of a CRM system for an end user of the CRM system. Thereafter, a document can be loaded into memory and parsed to extract a context for the document. The document can include, by way of example, an e-mail message or a speech recognition transcript. If the context can be matched to the scheduled meeting, the content of the document can be subjected to NLP in order to identify data pertaining to at least one CRM object in the CRM system. Thereafter, the CRM object can be updated with the identified data. Optionally, if a threshold period of time has elapsed from the scheduled occurrence of the meeting, the end user can be prompted by the CRM system to provide follow up in the document.

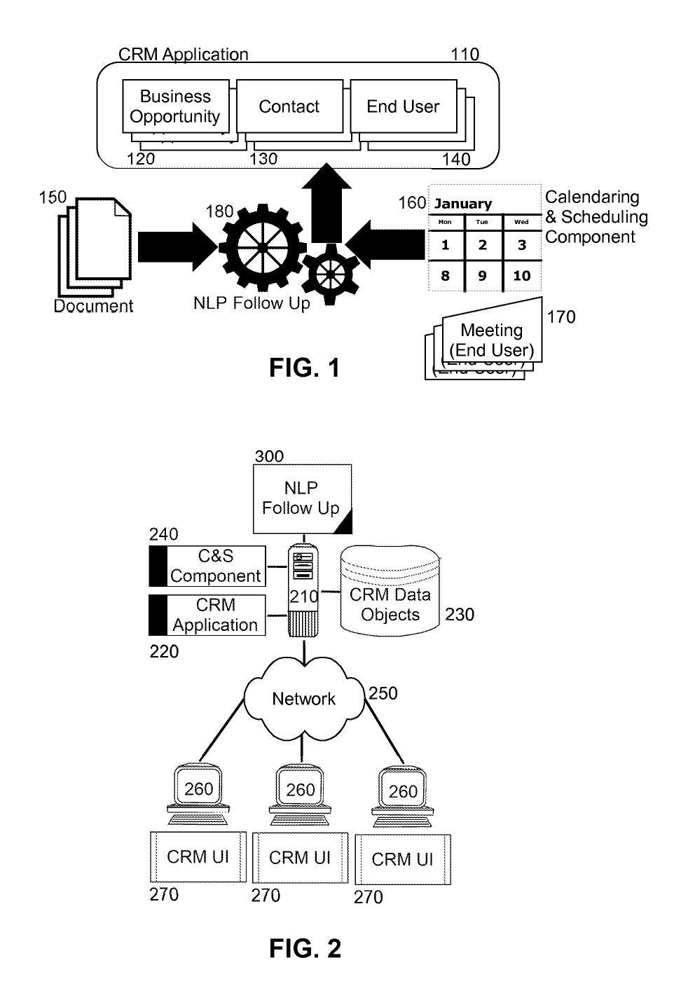

In further illustration, FIG. 1 pictorially shows a process for NLP follow up to a meeting in a C&S component of a CRM system. As shown in FIG. 1, a CRM application 110 can include different records 120, 130, 140 including business opportunity records 120, contact records 130 and end user records 140. The business opportunity records 120 include data pertaining to potential customers, the contact records 130 include data pertaining to individuals affiliated with the potential customers, and the end user records 140 pertaining to end users of the CRM application 110. Of note, a C&S component 160 can be coupled to the CRM application 110 and can manage the creation, modification and removal of different meeting events 170 for different end users of the CRM application 110.

NLP follow up logic 180 can be provided in connection with the CRM application 110 and the C&S component 160. The NLP follow up logic 180 can process one or more documents 150, for instance one or more e-mail messages, or the transcripts of voice recognized speech. The processing can include parsing the documents 150 to identify a context so as to correlate one or more of the documents 150 to particular ones of the meetings 170. For each of the documents 150 that correlates to a corresponding one of the meetings 170, the text of the documents 150 can be subjected to NLP to determine updated data for one more of the records 120, 130, 140 of the CRM application 110. The updated data then can be applied to the one or more of the records 120, 130, 140 in the CRM application 110.

The process described in connection with FIG. 1 can be implemented within a CRM data processing system. In yet further illustration, FIG. 2 schematically shows a CRM data processing system configured for NLP follow up to a meeting. The system can include a host computing system 210 that can include one or more computers each with memory and at least one processor. The host computing system 210 can support the operation of a CRM application 220. The CRM application 220 can be configured provide organization, automation and synchronization of sales, marketing, customer service, and support data embodied within different CRM data objects in a CRM data object store 230. In this regard, the CRM data objects can be records in the object 230, or more complex data structures persisted within the object store 230.

A C&S component 240 can execute in the host computing system 210 and can be logically coupled to the CRM application 220. The C&S component 240 can be configured to manage one or more different calendarable and schedulable events in association with one or more dates in a calendar. The C&S component 240 can be integrated with the operation of the CRM application 220 so as to permit an association between different calendared events and corresponding CRM data objects in the CRM data object store 170. As such, different end users of the CRM application 220 can establish and review calendar entries of the C&S component 240 by way of the CRM application 220 through a CRM user interface 270 displayed in a corresponding client computing device 260 communicatively linked to the host computing system 210 from over a computer communications network 250.

Of import, an NLP follow up module 300 also can execute in the memory of the host computing system 210. The NLP follow up module 300 can include program code enabled to process a document in order to determine a context for the document. The program code can utilize the context to associate the document with a previously scheduled meeting of the C&S component 240. The program code of the NLP follow up module 300 yet further can be enabled to apply NLP to text of the document to determine one or more updates to one or more of the CRM data objects in the CRM data objects store 230. Optionally, the program code of the NLP follow up module 300 can be enabled to trigger a generation of and a processing of the document subsequent to a threshold lapse of time subsequent to the scheduled meeting.

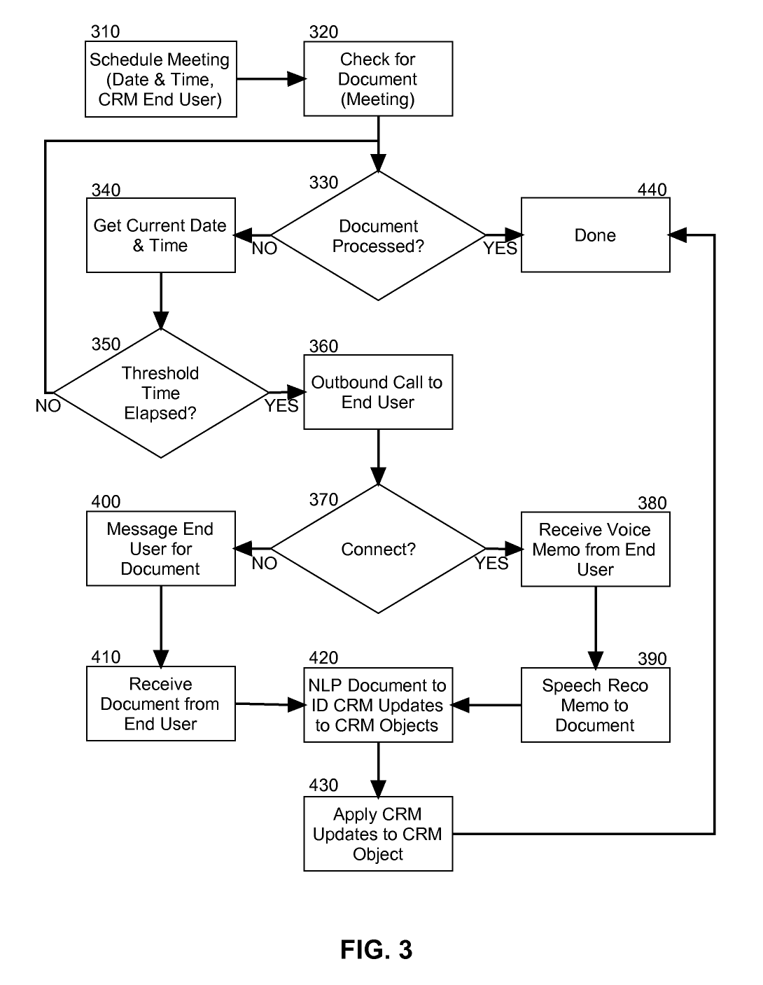

In even yet further illustration of the operation of the NLP follow up module 300, FIG. 3 is a flow chart illustrating a process for NLP follow up to a meeting in a C&S component of a CRM system. Beginning in block 310, a meeting can be scheduled by an end user of a CRM application at a particular date and time. In block 320, the CRM application can be queried for a document in connection with the scheduled meeting. In decision block 330, it can be determined whether or not a document has been processed in connection with the scheduled meeting. If so, the process can end in block 440. Otherwise, the process can proceed through block 340.

In block 340, a current date and time can be retrieved. In decision block 350, it can be determined whether or not a threshold period of time has elapsed since the scheduled meeting. If not, as before in decision block 330, it can be determined whether or not a document has been processed in connection with the scheduled meeting. If so, the process can end in block 440. Otherwise, the process once again can proceed through block 340. However, in decision block 350, if it is determined that a threshold period of time has elapsed since the scheduled meeting, in block 360 an outbound telephone call can be initiated to the end user associated with the scheduled meeting.

In decision block 370, it can be determined if a telephone call is successfully established with the end user. If so, in block 380 the end user can be prompted over the telephone call to record a voice memo summarizing the scheduled meeting and the voice memo can be received over the telephone call. In block 390 the voice memo can be subjected to speech recognition to produce a document pertaining to the scheduled meeting. However, if in decision block 370 it cannot be determined that a telephone call has been successfully established with the end user, in block 400 a message can be transmitted to the end user prompting the end user to generate a document summarizing the scheduled meeting. Thereafter, in block 410 the document can be received from the end user.

In decision block 420, the document can be processed according to NLP to identify CRM data object updates to CRM data objects in the CRM application. In particular, through NLP, different words and phrases in the document can be correlated to different CRM data objects and values extracted from the document by way of NLP. Subsequently, in block 430 the CRM data object updates can be applied to the CRM data objects and the process can end in block 440.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, a quantum-based storage device utilizing atomic or molecular state and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for natural language processing (NLP) follow up to a meeting in a calendaring and scheduling (C&S) component of a customer relationship management (CRM) system, the method comprising:
Scheduling a meeting from an end user in a C&S component of a CRM system executing in memory of host computing system;
Loading a document of the end user and extracting a context for the document;
Matching the context to the scheduled meeting and performing NLP on at least a portion of the document to produce data pertaining to at least one CRM object in the CRM system associated with the scheduled meeting; and,
Updating the CRM object with the produced data.

2. The method of claim 1, further comprising:
Determining that a threshold period of time has elapsed since a scheduled time for the meeting; and,
Prompting the end user to produce the document if the end user had not yet updated at least one CRM object in the CRM system associated with the scheduled meeting.

3. The method of claim 1, wherein the document is an e-mail message.

4. The method of claim 1, wherein the document is speech recognized text.

5. The method of claim 2, wherein the end user is prompted by way of a text message.

6. The method of claim 2, wherein the end user is prompted by way of an e-mail message.

7. The method of claim 2, wherein the end user is prompted by way of a voice prompt in automated telephone call and the document is produced by speech recognizing a voice message of the end recorded over the automated telephone call.

8. A customer relationship management (CRM) system configured for natural language processing (NLP) follow up to a meeting, the system comprising:
A host computing system comprising at least one computer with memory and at least one processor;
A CRM application with a calendaring and scheduling (C&S) component executing in the memory of the host computing system; and,
An NLP processing module coupled to the CRM application and the C&S component, the module comprising program code configured upon execution in the memory of the host computing system to schedule a meeting from an end user in the C&S component, to load a document of the end user and to extract a context for the document, to match the context to the scheduled meeting and performing NLP on at least a portion of the document to produce data pertaining to at least one CRM object in the CRM system associated with the scheduled meeting, and to update the CRM object with the produced data.

9. The system of claim 8, wherein the program code is further enabled to determine that a threshold period of time has elapsed since a scheduled time for the meeting and to prompt the end user to produce the document if the end user had not yet updated at least one CRM object in the CRM system associated with the scheduled meeting.

10. The system of claim 8, wherein the document is an e-mail message.

11. The system of claim 8, wherein the document is speech recognized text.

12. The system of claim 9, wherein the end user is prompted by way of a text message.

13. The system of claim 9, wherein the end user is prompted by way of an e-mail message.

14. The system of claim 9, wherein the end user is prompted by way of a voice prompt in automated telephone call and the document is produced by speech recognizing a voice message of the end recorded over the automated telephone call.

15. A computer program product for natural language processing (NLP) follow up to a meeting in a calendaring and scheduling (C&S) component of a customer relationship management (CRM) system, the computer program product comprising a computer readable storage medium having program instructions embodied therewith, the program instructions executable by a device to cause the device to perform a method comprising:
Scheduling by a device, a meeting from an end user in a C&S component of a CRM system executing in memory of host computing system;
Loading by the device a document of the end user and extracting a context for the document;
Matching by the device the context to the scheduled meeting and performing NLP on at least a portion of the document to produce data pertaining to at least one CRM object in the CRM system associated with the scheduled meeting; and,
Updating by the device the CRM object with the produced data.

16. The computer program product of claim 15, further comprising:
Determining by the device that a threshold period of time has elapsed since a scheduled time for the meeting; and,
Prompting by the device the end user to produce the document if the end user had not yet updated at least one CRM object in the CRM system associated with the scheduled meeting.

17. The computer program product of claim 15, wherein the document is an e-mail message.

18. The computer program product of claim 15, wherein the document is speech recognized text.

19. The computer program product of claim 16, wherein the end user is prompted by way of a text message.

20. The computer program product of claim 16, wherein the end user is prompted by way of an e-mail message.

21. The computer program product of claim 16, wherein the end user is prompted by way of a voice prompt in automated telephone call and the document is produced by speech recognizing a voice message of the end recorded over the automated telephone call.
